(19) United States
(12) Patent Application Publication
(10) Pub. No.: US 2023/0401490 A1
(43) Pub. Date: Dec. 14, 2023

(54) PREDICTING TRUE SAND RESISTIVITY IN LAMINATED SHALY SANDS WITH ARTIFICIAL INTELLIGENCE

(71) Applicant: Saudi Arabian Oil Company, Dhahran (SA)

(72) Inventors: Yacine Meridji, Dhahran (SA); Majed Fareed Kanfar, Dammam (SA); Christon Achong, Dhahran (SA); Charles Bradford, Dhahran (SA)

(21) Appl. No.: 17/838,728

(22) Filed: Jun. 13, 2022

(51) Int. Cl. G06N 20/20; G01V 3/26; E21B 49/00

(52) U.S. Cl. CPC G06N 20/20; G01V 3/26; E21B 49/00

(57) ABSTRACT

Systems, methods, and apparatus including computer-readable media for predicting true sand resistivity (RSS), for example, in laminated shaly sands, with artificial intelligence (AI) are provided. In one aspect, a computer-implemented method includes: obtaining basic log data of a target well, the basic log data including well logs of multiple types of the target well, and predicting a true sand resistivity (RSS) log of the target well using a trained artificial intelligence (AI) model with inputs including the well logs of the multiple types of the target well. The AI model was trained with well logs of the multiple types of existing wells as training inputs and known RSS logs for the existing wells as training outputs.

### TECHNICAL FIELD

The present disclosure relates to hydrocarbon reservoir properties, particularly to well logs.

### BACKGROUND

A hydrocarbon reservoir is a heterogeneous geological system with large intrinsic complexity. Reservoir porosity, permeability and hydrocarbon saturation are directly related to the storage capacity, fluid flow capacity and amount of hydrocarbon pore volume respectively. Problems related to reservoir characterization are difficult due to natural heterogeneity, uncertainty and nonlinearity in these reservoir parameters. Consequently, it is typically difficult to explicitly quantify variable reservoir properties.

A well log is a detailed record of geologic formations penetrated by a borehole. The well log may be based either on visual inspection of samples brought to the surface (geological logs) or on physical measurements made by instruments lowered into the hole (geophysical logs). Some types of geophysical well logs can be done during any phase of a well's history: drilling, completing, producing, or abandoning. The geophysical/geomechanical studies of the well logs can be used to determine hydrocarbons presence, determination of fluid type-gas, oil, water, bitumen, computation of porosity, computation of water saturation and lithology. However, drilling wells and obtaining a number of well logs are expensive and time consuming, with uncertainty of whether the drilled wells are not low productive. Thus, it is desirable to accurately estimate well log responses and/or reservoir properties before wells are drilled or legacy wells are re-drilled.

### SUMMARY

The present disclosure describes methods and systems for predicting hydrocarbon reservoir properties, e.g., true sand resistivity (RSS) well logs, in reservoirs, e.g., low resistivity laminated shaly or silty sand reservoirs, with artificial intelligence (AI), e.g., machine learning models or algorithms.

One aspect of the present disclosure features a computer-implemented method including: obtaining basic log data of a target well, the basic log data including well logs of multiple types of the target well; and predicting a true sand resistivity (RSS) log of the target well using a trained artificial intelligence (AI) model with inputs including the well logs of the multiple types of the target well, the AI model being trained with well logs of the multiple types of existing wells as training inputs and known RSS logs of the existing wells as a training output.

In some embodiments, the multiple types include two or more of resistivity, density, neutron, and gamma ray. In some embodiments, the known RSS logs of the existing wells were obtained based on at least one measurement of a multicomponent or tri-axial induction resistivity logging tool.

In some embodiments, the computer-implemented method further includes: determining one or more reservoir parameters for the target well based on the basic log data, the one or more reservoir parameters including at least one of volume of shale or volume of quartz. The AI model is trained with both the one or more reservoir parameters of the existing wells and the well logs of the multiple types of the existing wells as the training inputs. The RSS log of the target well is predicted using the trained AI model with the inputs including the one or more reservoir parameters of the target well and the well logs of the multiple types of the target well.

In some embodiments, the AI model includes a Random Forest model. In some embodiments, the computer-implemented method further includes: calculating a prediction accuracy of the AI model based on at least one of Mean absolute error (MAE) or root mean square error (RMSE); and in response to determining that the prediction accuracy of the AI model satisfies a predetermined threshold, determining the AI model has been successfully trained.

In some embodiments, the computer-implemented method further includes: after training the AI model, validating the trained AI model using well data of at least one test well adjacent to the target well. In some embodiments, the computer-implemented method includes one of: in response to determining that a prediction accuracy of the trained model using the at least one test well satisfies a predetermined threshold, predicting the RSS log of the target well using the trained AI model, or in response to determining that the prediction accuracy fails to satisfy the predetermined threshold, re-training the trained AI model based on a result of the validating.

In some embodiments, the target well is in a low resistivity laminated shaly or silty sand reservoir. In some embodiments, the target well is a drilled well. The well logs of the multiple types of the target well are recorded well logs for the target well, and the RSS log for the target well is non-recorded. In some embodiments, the target well and the existing wells for training the AI model are within a same reservoir. In some embodiments, the target well includes a vertical well.

In some embodiments, the computer-implemented method further includes: evaluating one or more hydrocarbon properties of the target well based on the predicted RSS log of the target well.

Another aspect of the present disclosure features a computer-implemented method, including: obtaining well data of a target well, the well data including well logs of multiple types of the target well; determining one or more reservoir parameters of the target well based on one or more of the well logs of the multiple types in the well data; and predicting a specific well log of the target well by a trained artificial intelligence (AI) model with the well logs of the multiple types of the target well and the one or more reservoir parameters of the target well as inputs of the AI model, the AI model being trained using well logs of the multiple types of existing wells and the one or more reservoir parameters of the existing wells as training inputs and known specific well logs for the existing wells as a training output.

In some embodiments, the specific well log includes a true sand resistivity (RSS) log. In some embodiments, the known specific well logs of the existing wells were obtained by measurements of a multicomponent or tri-axial induction resistivity logging tool.

In some embodiments, the multiple types include two or more of resistivity, density, neutron, and gamma ray, and the one or more reservoir parameters include at least one of volume of shale or volume of quartz.

In some embodiments, the target well is in a low resistivity laminated shaly or silty sand reservoir. The target well can include a drilled well. The well logs of the multiple types of the target well are recorded well logs of the target well, and the specific well log of the target well is non-recorded.

In some embodiments, the AI model includes a Random Forest model. The computer-implemented method can further include: calculating a prediction accuracy of the AI model based on at least one of Mean absolute error (MAE) or root mean square error (RMSE); and in response to determining that the prediction accuracy of the AI model satisfies a predetermined threshold, determining the AI model has been successfully trained.

Implementations of the above techniques include methods, systems, computer program products and computer-readable media. In one example, a method can be performed by at least one processor coupled to at least one non-volatile memory and the method can include the above-described actions. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions. In a further example, an apparatus or a system includes at least one processor and at least one non-volatile memory storing instructions executable by the at least one processor to perform the above-described actions.

The details of one or more implementations of the subject matter of this disclosure are set forth in the accompanying drawings and associated description. Other features, aspects, and advantages of the subject matter will become apparent from the description, the drawings, and the claims.

### DESCRIPTION OF DRAWINGS

FIG. 1 is a schematic diagram illustrating an example process of predicting well logs for target wells using a trained artificial intelligence (AI) model.

FIG. 2 is a schematic diagram illustrating an example of designating a target well in a reservoir having multiple existing wells.

FIG. 3 is a schematic diagram illustrating selecting training wells or testing wells for target wells based on location proximity in a field.

FIG. 4 shows example inputs and outputs for an artificial intelligence (AI) model.

FIGS. 5A-5B show correlations between predicted true sand resistivity (RSS) data by an artificial intelligence (AI) model and measured RSS data for a training set (FIG. 5A) and a testing set (FIG. 5B), respectively.

FIG. 6 is a flowchart of an example process of predicting RSS well logs with an artificial intelligence model.

### DETAILED DESCRIPTION

In low resistivity low contrast (LRLC) laminated shaly sand or silty sand reservoirs (e.g., having dirty sands, non-clean sandstones, etc.), the presence of shale and/or silt adversely affects observed resistivity measurements and makes the measured resistivity lower than actual sand resistivity or true sand resistivity. Conventional resistivity logs, e.g., true resistivity (Rt) or deep resistivity logs, as basic induction logs, normally fail in those laminated shaly sand or silty sand reservoirs and lead to underestimation of hydrocarbon reserves. For example, the conventional resistivity logs can result in estimation of higher water saturation in laminated sands, due to the laminated nature of rocks, and show interbedded sand/shale sequences to have the same low resistivity, resulting in a reduced hydrocarbon pore volume in place. Lateral Log Shallow (LLS) is a conventionally alternative log to induction logs in saline environment, which also fails to provide accurate estimation in laminated shaly sands.

True sand resistivity (RSS) log, as a specialty well log, can be used to enhance evaluation of low resistivity low contrast pay in clastic reservoirs. In some cases, a RSS log is acquired from actual measurements. For example, horizontal resistivity (RH) & vertical resistivity (RV) can be first acquired and then combined through a model to generate a RSS curve. However, thinly laminated pay or low resistivity pay zones can be anisotropic, horizontal resistivity (Rh) can be dominated by relatively conductive layers, and vertical resistivity (Rv) can be dominated by relatively resistive hydrocarbon strata, which can make measurements complicated or difficult to execute and/or make observed resistivity measurements not accurate. In some cases, a multicomponent or tri-axial induction resistivity logging technology (e.g., 3DEX, ZAIT, MCI) can aid to determine true sand resistivity. However, the technology and corresponding tools only came into existence since year 2001. That is, there is no way to determine true sand resistivity on wells that pre-dated the technology.

Implementations of the present disclosure provide methods, devices, systems, and techniques of predicting (or estimating) true sand resistivity (RSS) well logs using artificial intelligence (AI), e.g., machine learning (ML) models or algorithms, in low resistivity and/or low contrast laminated salty or silty sand reservoirs where conventional resistivity is limited by design due to the presence of shale/sand sequences in anisotropic rocks. The techniques herein can enable accurate water saturation estimation based solely on basic well logs that were recorded and available, and can be applied to wells where advanced tri-axial high-end induction resistivity logging tools did not exist or were not available, leading to more accurate reservoir estimates.

In some embodiments, the AI model is trained based on a plurality of existing wells that have tri-axial induction and basic log data (e.g., resistivity, density, neutron, and Gamma Ray). A full multi-mineral analysis can be performed on the basic log data to determine volume of shale (vol_shale) and volume of quartz (vol_quartz), then the AI model can use the volume of shale, the volume of quartz, and the basic logic data as training inputs, and known RSS data of the existing wells as training outputs to train the AI model. The RSS data can be obtained using actual measurements of horizontal resistivity (Rh) and vertical resistivity (Rv) or by a tri-axial induction resistivity logging tool. The AI model can be tested or validated blindly in wells nearby to a target well to ensure prediction accuracy. Then, the trained AI model can be used to predict a RSS log of a target well based on basic log data (e.g., resistivity, density, neutron, and Gamma Ray), volume of quartz, and volume of shale of the target well. The predicted RSS logs can be further used to evaluate hydrocarbon properties of the target well, e.g., to quantify a hydrocarbon pore volume.

In some embodiments, the AI model includes a machine learning model, e.g., Random Forest model, which can be trained based on mean absolute error (MAE) and/or root mean square error (RMSE). The Random Forest model can be optimized or improved using different cross-validation techniques. In some embodiments, the AI model includes an XGBoost model, a Support vector machine (SVM) model, or a neural network model.

One or more of the embodiments described herein can achieve a number of technical effects and advantages. For example, the techniques can address technical challenges existing for evaluating low resistivity low contrast (LRLC) laminated sand or silty sand reservoirs, where lamination and silt occurrence adversely effects on resistivity logging and negatively impacts water saturation calculation to make it too pessimistic. The techniques can address False Negative problem in evaluating thin bed laminated clastic reservoirs where conventional or standard evaluation misidentifies no hydrocarbon in place but the reservoirs actually have hydrocarbon, and can provide more accurate reservoir estimations/evaluations.

Compared to conventional resistivity logs that fail in laminated shaly sands and lead to underestimating hydrocarbon reserves, the techniques enable to provide accurate and reliable evaluations of wells and result in a significant increase in estimated hydrocarbon pore volume. The techniques can reduce uncertainty in reservoir estimations and allow for re-evaluation of low resistivity or laminated sands with increased confidence, which can provide fewer missed opportunities and better understanding of those low resistivity laminated shaly sand reservoirs, and can locate and produce previously bypassed pays or zones.

Compared to calculating RSS as a result of actual measurements, the techniques disclosed herein can bypass the acquisition of horizontal resistivity and vertical resistivity and modeling to combine them, and can predict or estimate RSS logs in wells that do not have such measurements or wells that have recorded basic log data but non-recorded RSS log due to missing or unavailability. The techniques can address any legal wells where there was no recorded measurements due to operational issues or any well before the introduction of the tri-axial induction technology in the early 2000's. The techniques can be also applied to new wells and can provide an excellent alternative if actual measurements are unable to acquire. The techniques can avoid acquiring high end logs such as image log, magnetic resonance or tri-axial induction log. Further, without actual measurements and using only basic well log data, the techniques can be relatively simple, economical, and quick.

The techniques can be easily deployable in any petrophysical or machine learning platforms. The techniques can be applied in vertical wells or deviated low resistivity laminated sands. The techniques can be applied to both oil and gas bearing reservoirs, e.g., in a same field or across multiple fields. The techniques can aid in planning formation tester pressure tests and sampling, and/or sidewall coring job design.

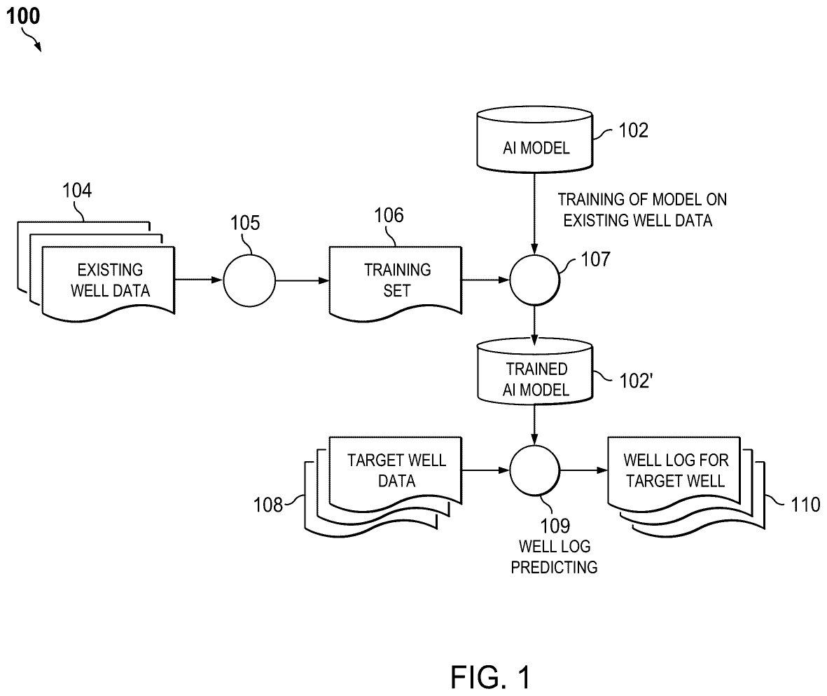

FIG. 1 is a schematic diagram illustrating an example process 100 of predicting well logs for target wells based on training an artificial intelligence (AI) model, e.g., a machine learning model. The process 100 can be implemented by a computing system that can include one or more computing devices and one or more machine-readable repositories or databases that are in communication with each other. The target wells can be legacy wells that had been drilled years ago, newly-drilled wells, or candidate wells to be drilled. The databases can store well logs, well location data of drilled wells in one or more hydrocarbon reservoirs, geological reservoir data, reservoir properties, and/or measurement data of the drilled wells. The computing system can use both spatial, geological settings, stratigraphic layering, and temporal properties to adjust intelligently to accurately estimate well logs in the target wells.

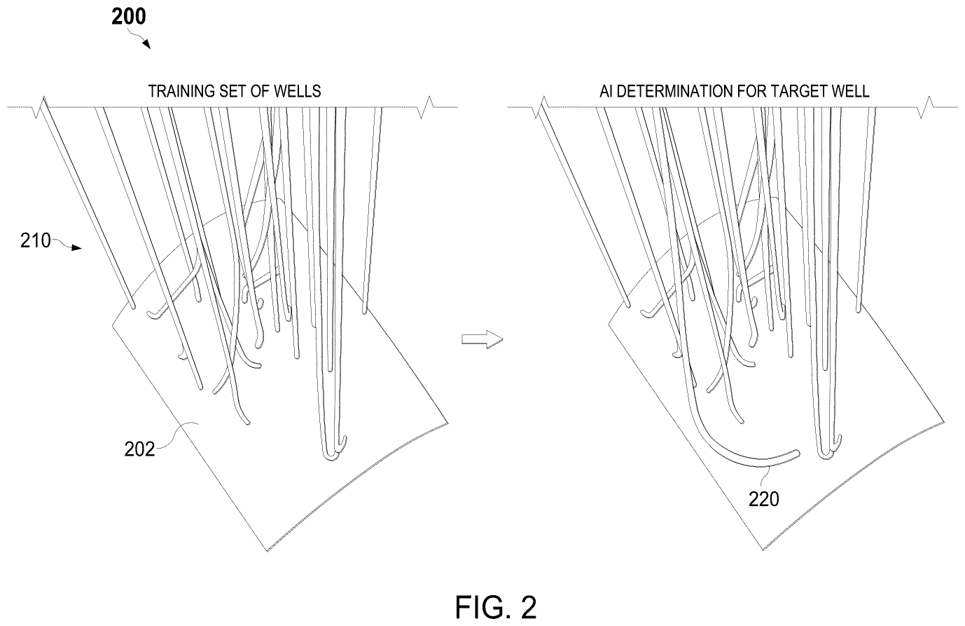

FIG. 2 shows an example 200 of designating a target well 220 in a hydrocarbon reservoir 202 where multiple training wells 210 can be previously drilled or formed. The hydrocarbon reservoir 202 can be laminated shaly sand or silty sand reservoirs (e.g., having dirty sands, non-clean sandstones, etc.) or low resistivity and/or low contrast reservoirs, or any suitable reservoirs. Each well 210 can be a borehole extending from a terranean surface (or the Earth's surface) to a respective subterranean zone of interest in the reservoir 202. The well 210 can be any suitable type of well, e.g., a well including a single wellbore or a well including multiple wellbores. The well 210 can be configured to produce hydrocarbon components, e.g., gas, oil, water, or any suitable combinations, from the respective subterranean zone in the reservoir 202. The wells 210 can be made at different times, e.g., with a difference of 5 years, 10 years, 20 years, years, or 50 years, and their well logs of the wells 210 can be temporally and spatially distributed among a wide time range.

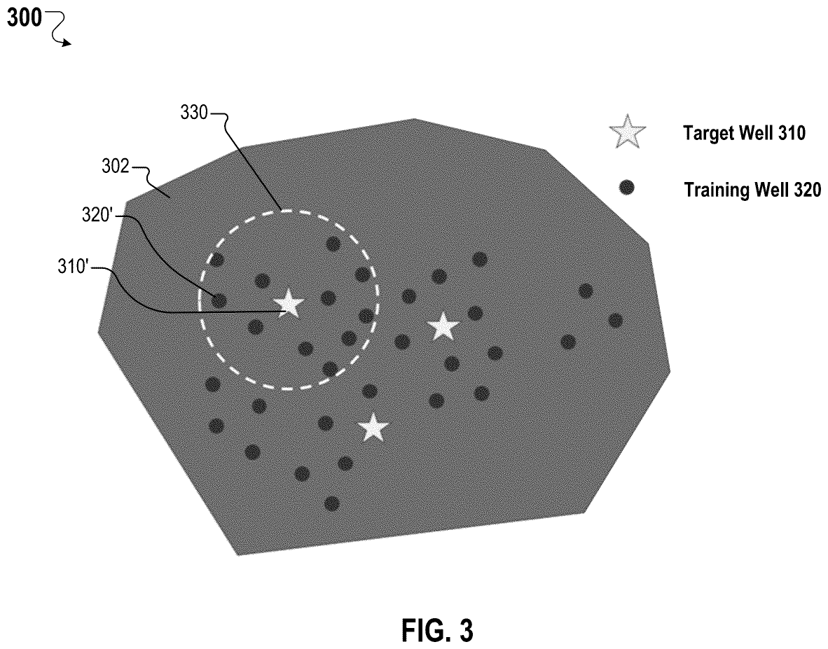

In some embodiments, the computing system selects training wells or testing wells that are located within a proximity of the target well 220, e.g., within a circle of 1 mile in radius. The location proximity can defined by a user or empirical data. FIG. 3 is a schematic diagram 300 illustrating selecting training or testing wells for a target well based on location proximity in a field 302. A number of wells are distributed in the field 302, including multiple target wells 310 with remaining wells as training wells (or testing wells) 320. For a particular target well 310′, the computing system can filter the number of wells by putting a circle 330 around the target well 310′, e.g., with the target well 310′ as the center of the circle 330. Wells within the circle 330 are selected as training wells (or testing wells) 320′ for the target well 310′ to be used.

The target well 220 can be a legacy well (or a drilled well) in the reservoir 202. Basic log data (e.g., logs of resistivity, density, neutron, and Gamma Ray) of the target well 220 can be recorded and available, but true sand resistivity (RSS) logs or associated measurements for the target well 220 are unrecorded, e.g., unavailable or missing. An operator can first identify the target well 220 and obtain available well data of the target well 220, e.g., the basic log data of the target well 220. Then the operator can select a plurality of wells 210 (or 320′) adjacent to the target well 220 (or 310′) within the reservoir 202 or a nearby reservoir. Each of the selected wells 210 (or 320′) has not only basic log data (e.g., logs of resistivity, density, neutron, and Gamma Ray) but also known true sand sensitivity (RSS) information (log or curve). The known RSS information of the selected well can be obtained from actual measurements (e.g., using tri-axial induction resistivity logging technology) or prediction/estimation (e.g., using a trained AI model such as 102′ described in the present disclosure). For example, after a RSS log of a first target well is obtained by a trained AI model, the first target well may be used as a training well or testing well for a second target well in training an AI model for the second target well.

With reference to FIG. 1, well data of selected existing wells, e.g., the training wells 210 in the reservoir 202 of FIG. 2 or the selected wells 320′ of FIG. 3, can be first processed at a processing step 105. In some embodiments, the processed well data is used as a training set 106. In some embodiments, the processed well data is divided into two groups: a training set and a testing set, where the training set is used to train an AI model, and the testing set is used to test or validate the trained AI model.

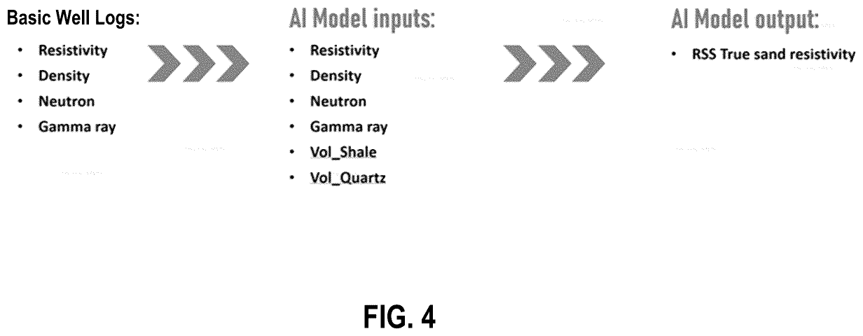

The well data includes basic log data that can include well logs of multiple types, e.g., resistivity, density, neutron, Gamma ray (GR), as illustrated in FIG. 4. The resistivity log can include true resistivity (Rt), deep resistivity (LLD), formation resistivity, shallow resistivity (LLS), or any suitable combination thereof. Note that the resistivity log in the basic log data is different from true sand resistivity (RSS) log. For each selected existing well, the well data also includes known true sand resistivity (RSS) log for the well, which can be obtained from actual measurements. For example, the RSS log can be obtained using measured horizontal resistivity (Rh) and vertical resistivity (Rv) or by a tri-axial induction resistivity logging tool. The neutron log can include neutron porosity (NPHT) log or compensation neutron log. The density log can include bulk density (RHOB) log or compensation density. The Gamma ray (GR) log can include corrected GR log. The well data can also include depth and geological information, or any related information.

In some embodiments, the well data of the existing wells can be filtered with a linear smoothing filter to remove outliers and artifacts in the data. The filter window size may either be chosen manually or be a fixed percentage of the overall data length. The training set 106 may also be visually inspected for erroneous artifacts. The processed data can be categorized, and may be reduced further if desired.

In some embodiments, for each selected existing well, a full multi-mineral analysis is performed on the basic log data to determine volume of shale (vol_shale) and volume of quartz (vol_quartz) of the well. For example, the volume of shale and the volume of quartz can be obtained, e.g., by a mathematical equation, model or algorithm, according to the basic log data, including one or more of Gamma Ray log, resistivity log, density log, and neutron log.

Finally, the data are separated into input parameters and output parameters for training the AI model 102. The training set 106 can include well logs of resistivity, density, neutron, Gamma ray, and volume of shale (vol_shale) and volume of quartz (vol_quartz) of the training wells as input parameters of the AI model 102, and the true sand resistivity (RSS) logs of the training wells as output parameters of the AI model 102, e.g., as illustrated in FIG. 4.

The computing system can train an artificial intelligence (AI) model 102 with respect to the training set 106 at a processing step 107 and return a trained AI model 102′. In some embodiments, the AI model 102 includes an XGBoost model, a Support vector machine (SVM) model, or a neural network model. In some embodiments, the AI model 102 can be a machine learning (ML) model, e.g., Random Forest model. The Random Forest model can be optimized or improved using different cross-validation techniques, e.g., K-folds cross-validation, Hold-Out cross-validation, repeated K-folds cross-validation, stratified K-folds cross-validation, group K-folds cross-validation, or Shuffle Split cross-validation, etc. In some embodiments, cross-validation calculates an accuracy of an AI model by separating a data set into two different sets: a training set and a testing set. In n-fold cross-validation, the data set is randomly partitioned into n mutually exclusive folds, T1, T2, . . . , Tn, each having an approximately equal size. Training and testing are performed n times. Each training set is composed of (n−1)/n of the data set and the remaining 1/n of the data set is used as testing data. For example, in 10-fold cross-validation, a given data set is partitioned into ten subsets. Out of these ten subsets, nine subsets are used to perform a training fold and a single subset is retained as testing data. Then a cross-validation process is repeated for the number of folds, e.g., ten times. The ten sets of results are then aggregated by averaging to produce a single model estimation. The advantage of ten-fold cross-validation over random sub sampling is that all objects in the data set are used for both training and testing, and each object is used for testing only once per fold.

In some embodiments, the AI model 102, e.g., the Random Forest model, is trained based on at least one of mean absolute error (MAE) or root mean square error (RMSE). The MAE and RMSE can be used to measure a prediction accuracy of the Random Forest model. The MAE and RMSE can be defined as:

$$M A E = \frac{{\sum }_{i = 1}^{N} ( {y}_{i} - {\hat{y}}_{ι} )}{N} ,$$

$$and$$

$$R M S E = \sqrt{\frac{{\sum }_{i = 1}^{N} {( {y}_{i} - {\hat{y}}_{ι} )}^{2}}{N}} ,$$

where N is the number of points in the well-logging RSS curves, and yᵢ and ŷₜ are measured RSS data and predicted RSS data, respectively. Note that the term “measured RSS data” indicates that the RSS data is obtained based on actual measurements.

In some embodiments, the computing system determines a prediction accuracy for the AI model based on at least one of MAE or RMSE. The computing system can set a predetermined threshold, e.g., an acceptable correlation coefficient or an acceptable MAE or RMSE error. The computing system can determine whether the prediction accuracy satisfies the predetermined threshold. If the prediction accuracy satisfies the predetermined threshold, the computing system can determine that the AI model has been successfully trained. If the prediction accuracy fails to satisfy the predetermined threshold, the computing system can determine that the AI model has not been successfully trained. In response, the computing system can re-train the AI model, e.g., by adjusting one or more parameters of the AI model based on a comparison between the prediction accuracy and the predetermined threshold or adjusting the training wells.

If the correlation coefficient (R2) is used to represent the prediction accuracy, the computing system determines whether the prediction accuracy satisfies the predetermined threshold by determining whether the correlation coefficient is greater than the predetermined threshold. If the MAE or RMSE error is used to represent the prediction accuracy, the computing system determines whether the prediction accuracy satisfies the predetermined threshold by determining whether the MAE or RMSE error is smaller than the predetermined threshold.

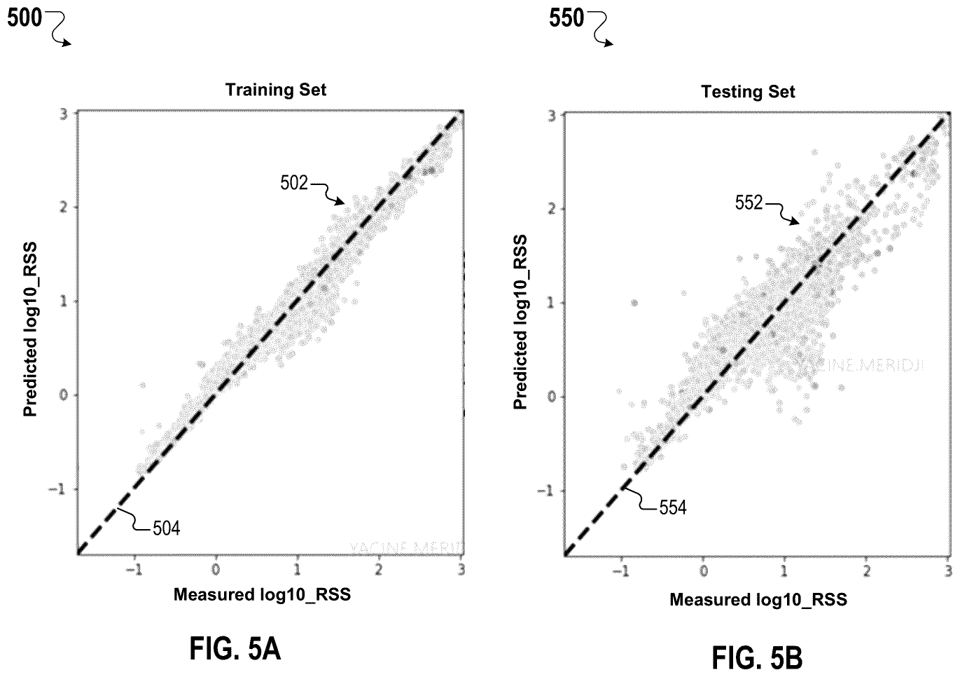

FIG. 5A is a diagram 500 showing an example correlation between measured RSS data and predicted RSS data (e.g., using the trained AI model 102′ of FIG. 1) for a training set (e.g., the training set 106 of FIG. 1). A group of points 502 represent correlation points of the measured RSS data and the predicted RSS data. Dotted line 504 represents a correlation coefficient R2 for the group of points 502. Results for the training set are: MAE (0.071727), RMSE (0.107170), and R2 (0.982044). It is shown that the predicted RSS data by the trained AI model has matched well with the RSS data from actual measurement. The high correlation coefficient (e.g., R2) and/or low error rate (e.g., MAE or RMSE) can indicate that the AI model has been successfully trained.

After determining that the AI model 102 has been successfully trained, the computing system can further test or validate the trained AI model 102′, e.g., blindly, to ensure the prediction accuracy, using a testing set including one or more testing wells nearby to the target well. As noted above, the testing set can be obtained from the processed well data at step 105. The testing wells can include the wells 210 of FIG. 2 in the same reservoir or the selected wells 320′ of FIG. 3 in the same field. The testing wells can include newly-drilled wells adjacent to the target well, which can ensure the prediction accuracy for the target well.

FIG. 5B is a diagram 550 showing an example correlation between measured RSS data and predicted RSS data (e.g., using the trained AI model 102′ of FIG. 1) for a testing set. A group of points 552 represent correlation points of the measured RSS data and the predicted RSS data of the testing set. Dotted line 554 represents a correlation coefficient R2 for the group of points 552. Results for the testing set are: MAE (0.183951), RMSE (0.270722), and R2 (0.883427). It is shown that, although the prediction accuracy for the testing set is lower than that for the training set (as shown in FIG. 5A), the prediction accuracy still indicates that the trained AI model provides a high prediction accuracy for the testing wells and a consistent agreement between the predicted RSS data and the measured RSS data. The computing system can also determine whether the prediction accuracy for the testing set satisfy a predetermined threshold that can be same as or smaller than the predetermined threshold for the training set.

In some embodiments, in response to determining that the prediction accuracy fails to satisfy the predetermined threshold or has a big different from the prediction accuracy using the training set, the computing system can re-train the AI model, e.g., including the testing set in the training set or selecting new existing wells for the training set. In some embodiments, in response to determining that a prediction accuracy of the trained model using the testing set satisfies a predetermined threshold, the computing system can proceed to predict RSS log of the target well using the trained AI model.

At a processing step 109, the computing system uses the trained AI model 102′ together with target well data 108 of a target well to predict (or estimate) a specific well log (e.g., RSS log) 110 of the target well. The target well data 108 can be conformed with respect to information of the training wells as the training set 106. For example, the target well data 108 can include basic log data of the target well (e.g., resistivity, density, neutron, Gamma ray), which were known, recorded, and available, and one or more reservoir parameters (e.g., volume of shale and volume of quartz) determined based on the basic log data of the target well. The predicted RSS log 110 can be further used to evaluate hydrocarbon properties of the target well, e.g., to quantify a hydrocarbon pore volume. In some embodiments, the target well with the predicted RSS log and the basic log data can be used as a training well to train a new AI model for a new target well.

In some embodiments, the target well is a vertical well, and an AI model can be trained for the target well as a vertical well. In some embodiments, the target well is a horizontal well, and an AI model can be trained for the target well as a horizontal well. In some embodiments, an AI model can be trained for both a vertical well and a horizontal well.

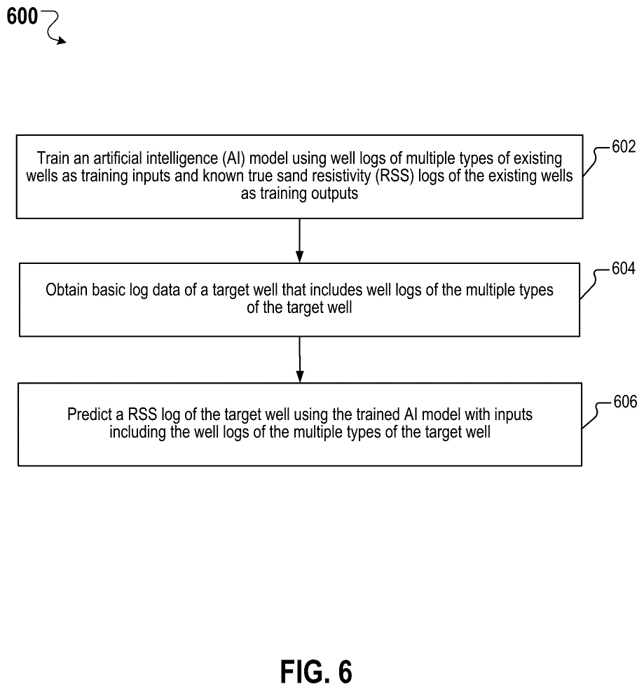

FIG. 6 is a flowchart of an example process 600 of predicting a true sand resistivity (RSS) well log of a target well with an artificial intelligence model. The process 600 can be performed by a computing system. The computing system can include one or more computing devices and one or more machine-readable repositories or databases that are in communication with each other. The process 600 can be implemented as part or all of the process 100 described in FIG. 1.

The target well is a well of interest, e.g., a well in a low resistivity laminated shaly or silty sand reservoir. The target well can be a vertical well or deviated well in low resistivity laminated sands. The target well can be the target well 220 of FIG. 2 or 310′ of FIG. 3. In some cases, the target well is a drilled well that was legally drilled or newly drilled. In some cases, the target well is a well to be drilled, and well data of the target well can be obtained by estimation, e.g., by another AI model or algorithm.

At step 602, the AI model is trained using well logs of multiple types of existing wells as training inputs and known true sand resistivity (RSS) logs of the existing wells as training outputs. The AI model can be the AI model 102 of FIG. 1. Step 602 can be implemented like step 107 of FIG. 1. The existing wells can be selected for the target well, e.g., as described in FIG. 2 or FIG. 3. For example, the target well and the existing wells for training the AI model can be within a same reservoir.

The multiple types of well logs can include two or more of resistivity, density, neutron, and gamma ray. The RSS logs of the existing wells can be obtained based on actual measurements, e.g., by a multicomponent or tri-axial induction resistivity logging tool. In some embodiments, one or more reservoir parameters for each existing well are obtained based on one or more types of well logs in the basic log data. The one or more reservoir parameters can include at least one of volume of shale or volume of quartz. The AI model can be trained with both the one or more reservoir parameters of the existing wells and the multiple types of well logs measured for the existing wells as the training inputs, e.g., as illustrated in FIG. 4.

In some embodiments, the AI model includes a machine learning model, e.g., a Random Forest model. The AI model can be trained by calculating a prediction accuracy of the AI model based on at least one of Mean absolute error (MAE) or root mean square error (RMSE). As illustrated in FIG. 5A, the MAE and RMSE can be obtained by correlating predicted RSS data and known RSS data of the existing wells. A correlation coefficient (R2) can be obtained based on correlation points. The correlation coefficient or the MAE or RMSE error can be used to represent the prediction accuracy. The computing system can determine whether the prediction accuracy satisfies a predetermined threshold. In response to determining that the prediction accuracy of the AI model satisfies the predetermined threshold, the computing system can determine that the AI model has been successfully trained. In response to determining that the prediction accuracy of the AI model fails to satisfy the predetermined threshold, the computing system can re-train the AI model by adjusting one or more parameters of the AI model or adjusting training wells.

In some embodiments, after the AI model has been trained, the computing system can test or validate the trained AI model using well data of at least one test well adjacent to the target well, e.g., by calculating a prediction accuracy as illustrated in FIG. 5B. For example, in response to determining that a prediction accuracy of the trained AI model using the at least one test well fails to satisfy a predetermined threshold, the computing system can re-train the AI model by adjusting one or more parameters of the AI model or adjusting training wells for the AI model. In response to determining that the prediction accuracy of the training model using the at least one test well satisfies the predetermined threshold, the computing system can proceed to use the trained AI model to predict RSS log for the target well, as shown in step 606.

At step 604, basic log data of the target well is obtained. The basic log data includes well logs of the multiple types of the target well that are the same types of the existing wells for training, e.g., two or more of resistivity, density, neutron, and gamma ray. The well logs of the target well are recorded well logs for the target well, and RSS log for the target well is non-recorded, e.g., unavailable or missing. In some embodiments, as noted above, one or more reservoir parameters for the target well can be determined based on the basic log data, e.g., volume of shale and volume of quartz.

At step 606, RSS log of the target well is predicted using the trained AI model, e.g., as illustrated as step 109 of FIG. 1. The inputs of the trained AI model can include the well logs of the multiple types of the target well and the determined one or more reservoir parameters.

In some embodiments, the process 600 further includes evaluating hydrocarbon properties of the target well based on the predicted RSS log for the target well, which can provide more accurate reservoir estimations/evaluations for the target well.

Implementations of the subject matter and the functional operations described in this disclosure can be implemented in digital electronic circuitry, in tangibly embodied computer software or firmware, in computer hardware, including the structures disclosed in this disclosure and their structural equivalents, or in combinations of one or more of them. Implementations of the subject matter described in this disclosure can be implemented as one or more computer programs, such as, one or more modules of computer program instructions encoded on a tangible, non-transitory computer-storage medium for execution by, or to control the operation of, data processing apparatus. Alternatively or in addition, the program instructions can be encoded on an artificially generated propagated signal, such as, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus and special purpose logic circuitry may be hardware-based and software-based. The apparatus can optionally include code that creates an execution environment for computer programs, for example, code that constitutes processor firmware, a protocol stack, a database management system, an operating system, or a combination of one or more of them. The present disclosure contemplates the use of data processing apparatuses with or without conventional operating systems.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this disclosure can be performed by one or more programmable computers executing one or more computer programs to perform functions by operating on input data and generating output. The processes and logic flows can also be performed by, and apparatus can also be implemented as, special purpose logic circuitry, such as, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD-R, DVD-RAM, and DVD-ROM disks. The memory may store various objects or data, including caches, classes, frameworks, applications, backup data, jobs, web pages, web page templates, database tables, repositories storing business and dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this disclosure can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include multiple user interface (UI) elements, some or all associated with a web browser, such as interactive fields, pull-down lists, and buttons operable by the business suite user. These and other UI elements may be related to or represent the functions of the web browser.

Implementations of the subject matter described in this disclosure can be implemented in a computing system that includes a back-end component, for example, as a data server, or that includes a middleware component, for example, an application server, or that includes a front-end component, for example, a client computer having a graphical user interface or a web browser through which a user can interact with an implementation of the subject matter described in this disclosure, or any combination of one or more such back-end, middleware, or front-end components. The components of the system can be interconnected by any form or medium of wireline or wireless digital data communication, for example, a communication network. Examples of communication networks include a local area network (LAN), a radio access network (RAN), a metropolitan area network (MAN), a wide area network (WAN), worldwide interoperability for microwave access (WIMAX), a wireless local area network (WLAN) using, for example, 902.11 a/b/g/n and 902.20, all or a portion of the Internet, and any other communication system or systems at one or more locations. The network may communicate with, for example, internet protocol (IP) packets, frame relay frames, asynchronous transfer mode (ATM) cells, voice, video, data, or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and software, may interface with each other or the interface using an application programming interface (API) or a service layer. The API may include disclosures for routines, data structures, and object classes. The API may be either computer language-independent or -dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in any suitable language providing data in any suitable format. The API and service layer may be an integral or a stand-alone component in relation to other components of the computing system. Moreover, any or all parts of the service layer may be implemented as child or sub-modules of another software module, enterprise application, or hardware module without departing from the scope of this disclosure.

While this disclosure contains many specific implementation details, these should not be construed as limitations on the scope of any invention or on the scope of what may be claimed, but rather as descriptions of features that may be specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products.

Accordingly, the earlier provided description of example implementations does not define or constrain this disclosure. Other changes, substitutions, and alterations are also possible without departing from the spirit and scope of this disclosure.

What is claimed is:

1. A computer-implemented method, comprising:
obtaining basic log data of a target well, the basic log data comprising well logs of multiple types of the target well; and
predicting a true sand resistivity (RSS) log of the target well using a trained artificial intelligence (AI) model with inputs comprising the well logs of the multiple types of the target well, the AI model being trained with well logs of the multiple types of existing wells as training inputs and known RSS logs of the existing wells as a training output.

2. The computer-implemented method of claim 1, wherein the target well is in a low resistivity laminated shaly or silty sand reservoir.

3. The computer-implemented method of claim 1, wherein the multiple types comprise two or more of resistivity, density, neutron, and gamma ray.

4. The computer-implemented method of claim 1, further comprising:
determining one or more reservoir parameters for the target well based on the basic log data, wherein the one or more reservoir parameters comprise at least one of volume of shale or volume of quartz,
wherein the AI model is trained with both the one or more reservoir parameters of the existing wells and the well logs of the multiple types of the existing wells as the training inputs, and
wherein the RSS log of the target well is predicted using the trained AI model with the inputs comprising the one or more reservoir parameters of the target well and the well logs of the multiple types of the target well.

5. The computer-implemented method of claim 1, wherein the known RSS logs of the existing wells were obtained based on at least one measurement of a multicomponent or tri-axial induction resistivity logging tool.

6. The computer-implemented method of claim 1, wherein the AI model comprises a Random Forest model.

7. The computer-implemented method of claim 1, further comprising:
calculating a prediction accuracy of the AI model based on at least one of Mean absolute error (MAE) or root mean square error (RMSE); and
in response to determining that the prediction accuracy of the AI model satisfies a predetermined threshold, determining the AI model has been successfully trained.

8. The computer-implemented method of claim 1, further comprising:
after training the AI model, validating the trained AI model using well data of at least one test well adjacent to the target well.

9. The computer-implemented method of claim 8, comprising one of:
in response to determining that a prediction accuracy of the trained model using the at least one test well satisfies a predetermined threshold, predicting the RSS log of the target well using the trained AI model, or
in response to determining that the prediction accuracy fails to satisfy the predetermined threshold, re-training the trained AI model based on a result of the validating.

10. The computer-implemented method of claim 1, further comprising:
evaluating one or more hydrocarbon properties of the target well based on the predicted RSS log of the target well.

11. The computer-implemented method of claim 1, wherein the target well is a drilled well, and
wherein the well logs of the multiple types of the target well were recorded, and the RSS log of the target well was non-recorded.

12. The computer-implemented method of claim 1, wherein the target well and the existing wells for training the AI model are within a same reservoir.

13. A computer-implemented method, comprising:
obtaining well data of a target well, the well data comprising well logs of multiple types of the target well;
determining one or more reservoir parameters of the target well based on one or more of the well logs of the multiple types in the well data; and
predicting a specific well log of the target well by a trained artificial intelligence (AI) model with the well logs of the multiple types of the target well and the one or more reservoir parameters of the target well as inputs of the AI model, the AI model being trained using well logs of the multiple types of existing wells and the one or more reservoir parameters of the existing wells as training inputs and known specific well logs for the existing wells as a training output.

14. The computer-implemented method of claim 13, wherein the specific well log comprises a true sand resistivity (RSS) log.

15. The computer-implemented method of claim 14, wherein the known specific well logs for the existing wells were obtained by measurements of a multicomponent or tri-axial induction resistivity logging tool.

16. The computer-implemented method of claim 14, wherein the multiple types comprise two or more of resistivity, density, neutron, and gamma ray, and
wherein the one or more reservoir parameters comprise at least one of volume of shale or volume of quartz.

17. The computer-implemented method of claim 14, wherein the target well is in a low resistivity laminated shaly or silty sand reservoir.

18. The computer-implemented method of claim 14, wherein the target well comprises a drilled well, and wherein the well logs of the multiple types of the target well are recorded well logs of the target well, and the specific well log of the target well is non-recorded.

19. The computer-implemented method of claim 14, wherein the AI model comprises a Random Forest model,
wherein the computer-implemented method further comprises:
calculating a prediction accuracy of the AI model based on at least one of Mean absolute error (MAE) or root mean square error (RMSE); and
in response to determining that the prediction accuracy of the AI model satisfies a predetermined threshold, determining the AI model has been successfully trained.

20. A computing system comprising:
at least one processor; and
at least one non-transitory machine readable storage medium coupled to the at least one processor having machine-executable instructions stored thereon that, when executed by the at least one processor, cause the at least one processor to perform operations comprising:
obtaining basic log data of a target well, the basic log data comprising well logs of multiple types of the target well, the multiple types comprising two or more of resistivity, density, neutron, and gamma ray; and
predicting a true sand resistivity (RSS) log of the target well using a trained artificial intelligence (AI) model with inputs comprising the well logs of the multiple types of the target well, the AI model being trained with well logs of the multiple types of existing wells as training inputs and known RSS logs of the existing wells as a training output.
